(19) United States
(12) Patent Application Publication
(10) Pub. No.: US 2026/0065114 A1
(43) Pub. Date: Mar. 5, 2026

(54) SILICON-BASED QUANTUM PROCESSOR

(71) Applicant: Quantum Motion Technologies Limited, London, Greater London (GB)

(72) Inventors: Miguel Fernando Gonzalez-Zalba, London, Greater London (GB); Ross Cho Chun Leon, London, Greater London (GB)

(21) Appl. No.: 19/104,570

(22) PCT Filed: Oct. 4, 2023
(86) PCT No.: PCT/EP2023/077496

§ 371 Date: Feb. 18, 2025

(30) Foreign Application Priority Data
Oct. 12, 2022 (EP) 22201015.9

(51) Int. Cl. G06N 10/40

(52) U.S. Cl. CPC G06N 10/40

(57) ABSTRACT

A silicon-based quantum processor is disclosed comprising a plurality of unit cells having respective qudits that can interact with one another, directly or indirectly. Each unit cell comprises a charge reservoir (101) and a plurality of single-electron boxes, SEBs, (103a,b,c,d) that are gated charged islands separated from the charge reservoir by a tunnel barrier. A first plurality of qudits for use as ancilla qudits (105a,b) are provided around each SEB. A second plurality of qudits (107a,b) for use as data qudits are provided around the first plurality of qudits. Each of the second plurality of qudits can interact with at least one of the first plurality of qudits so that the state of each of the second plurality of qudits can be read by one of the plurality of SEBs from a neighbouring one of the first plurality of qudits.

### FIELD OF THE INVENTION

The invention relates to silicon-based quantum processors.

### BACKGROUND

Quantum processors based on silicon-based semiconductor materials (hereinafter “silicon-based quantum processors”) are a leading candidate in the development of quantum computers.

Quantum processors perform calculations by manipulating arrays of qudits (i.e. elementary units of quantum information having an integer number, d, of possible states—for example qubits, which have two possible states, analogous to bits in classical computing). In many architectures there are ancilla qudits, whose states are read and manipulated directly by the apparatus of the processor, and data qudits, on which the calculations are performed but whose states are not directly controlled or read. The ancilla qudits are arranged to interact with (at least some of) the data qudits so that the data qudits and ancilla qudits can influence one another's state. This allows the outputs of calculations performed by the data qudits to be read without directly interacting with the data qudits, and the states of data qudits in direct communication with the ancilla qudits can be read by measurements of the ancilla qudits.

Typically, each qudit can interact directly with the other qudits nearest to it in the array: for example, in a linear array of qudits, each qudit may be able to interact directly with the qudits immediately either side of it. In some computing applications, it is desirable that the data qudits have a high degree of two-dimensional (2D) connectivity—i.e. that at least some of the data qudits are in direct communication with as many other data qudits as possible. There is therefore a need for quantum processor architectures that enable a high level of connectivity between data qudits. Additionally, it is sometimes desirable that the states of most or all of the data qudits can be read, which requires that all of the data qudits are in communication with one or more ancilla qudits. It will be apparent that there is a trade-off between, on one hand, high connectivity and, on the other, the proportion of data qudits whose states can be read. This is the case since the more data qudits are arranged to interact with at least one ancilla qudit, the fewer connections there can be between data qudits. There is a need for a quantum processor architecture that can meet these demands.

### SUMMARY OF THE INVENTION

The invention provides a silicon-based quantum processor, comprising a plurality of unit cells having respective qudits that can interact with one another, directly or indirectly, wherein each unit cell comprises: a charge reservoir; a plurality of single-electron boxes, SEBs, that are gated charged islands separated from the charge reservoir by a tunnel barrier; a first plurality of qudits for use as ancilla qudits, provided around each SEB, and to which the SEB is sensitive, wherein the first plurality of qudits are provided around the charge reservoir and the plurality of SEBs; and a second plurality of qudits for use as data qudits provided around the first plurality of qudits, wherein each of the second plurality of qudits can interact with at least one of the first plurality of qudits so that the state of each of the second plurality of qudits can be read by one of the plurality of SEBs from a neighbouring one of the first plurality of qudits.

The reservoir is typically an electrode or other component capable of supplying charge carriers to the SEBs in its vicinity. As noted above, an SEB is a gated island separated from the charge reservoir by a tunnel barrier. In use a gate voltage is applied to the island, and the number of charge carriers that may occupy the island is a function of this gate voltage. This configuration allows charge carriers to be transported between the reservoir and the first plurality of qudits arranged around the reservoir. The SEBs are also capable of sensing the state of the first plurality of qudits to which they are sensitive (which will typically be the qudit(s) that are physically nearest the SEB). The SEBs thus serve two purposes: transporting charges between the reservoir and the first plurality of qudits and sensing the states of the first plurality of qudits.

In the configuration set out above, a quantum processor can be established that enables a high density of data qudits in a processor, while allowing the state of these data qudits to be readout using the SEBs. This has been achieved in part thanks to the inventors'realisation that multiple SEBs can be arranged around a single charge reservoir, thereby allowing each reservoir to serve more qudits (and hence reducing the number of reservoirs required) than in known architectures. The units cells can be connected to one another to facilitate sparse 2D connectivity of data qudits while enabling readout of data qudits, using neighbouring ancilla qudits. In some configurations it is possible to achieve readout of all data qudits in the array, which achieves a highly desirable balance between the desire for high 2D connectivity, while enabling space on the processor for the state of data qudits to be read.

The qudits may be qubits, having two possible states, or could have some other number of states. In preferred implementations the qudits are implemented as gated semiconductor quantum dots in which charge carriers (e.g. electrons) can be confined. In these implementations, the charge carriers can be confined by application of a suitable electrostatic potential to the gate.

Preferably, at least some of the second plurality of qudits of one or more of the unit cells are configured to interact with at least some of the second plurality of qudits of one or more other unit cells. In this arrangement, the second plurality of qudits (which will serve as data qudits in use) of adjacent unit cells may interact with one another, which achieves greater 2D connectivity than is present in the plurality of units cells in isolation from one another. In general, the more other data qudits each data qudit can interact with, the greater the 2D connectivity of the processor is.

In preferred implementations, within each unit cell: the first plurality of qudits are arranged in a first ring around the charge reservoir and the plurality of SEBs; and the second plurality of qudits comprise qudits arranged in a second ring around the first ring. In these embodiments, there are ancilla qudits arranged around each SEB in a first ring. The term “ring” here signifies that the ancilla qudits are arranged about the perimeter formed by the SEBs and the reservoir. This arrangement enables the ancilla qudits to interact in the required manner with the SEBs. It will be appreciated that the term “ring” does not imply any specific shape, as will be apparent in light of the detailed examples described below. Similarly, the plurality of data qudits arranged in the second ring are arranged around the perimeter formed by the ancilla qudits. As will be discussed below, there may be other data qudits in addition to those in the second ring.

In some preferred implementations, at least some of the qudits in the second ring of a first unit cell are configured to interact with at least some of the qudits in the second ring of a second unit cell. In embodiments such as these, where qudits in the second rings of different unit cells are arranged to interact with one another, it is possible for a significant proportion (or indeed all) of the data qudits to be read via the first plurality of qudits (ancilla qudits) since there may be few (or no) data qudits that are not in communication with ancilla qudits.

In other preferred embodiments, the second plurality of qudits in each unit cell are provided in the second ring and in a third ring, which surrounds the second ring, wherein each of the qudits in the second ring can interact with at least one of the qudits in the third ring. By providing a third ring of qudits (which, the like qudits in the second ring, belong to the second plurality of qudits and are hence suitable for use as data qudits) around the second ring, greater 2D connectivity of data qudits can be achieved since each data qudit will have more other data qudits in its vicinity and a greater proportion of each unit cell will be occupied by data qudits. Preferably at least some of the qudits in the third ring of a first unit cell are configured to interact with at least some of the qudits in the third ring of a second unit cell. There could be one or more further rings of data qudits around the third ring, which would further increase 2D connectivity.

Advantageously, within each unit cell, four SEBs are provided around the charge reservoir in a rectangular configuration. The term “rectangular” here encompasses square and other rectangular layouts. This configuration achieves an efficient use of space in the layout of the processor since all sides of the reservoir may be provided with an SEB, which in turn permits a high number of ancillia qudits (the first plurality of qudits) and data qudits (the second plurality of qudits) to be arranged around each reservoir. Preferably, in these embodiments, three of the first plurality of qudits are provided around each of the four SEBs of each unit cell. For example, there could be one of the first plurality of qudits on each of three sides of the SEB, with the fourth side of the SEB arranged to communicate or interact with the reservoir. As will be illustrated with reference to examples below, there are not necessarily a different three qudits for each SEB, since some of the first plurality of qudits may be arranged to interact with more than one SEB. For example, preferably eight qudits are provided in the first ring of each unit cell and twelve of the second plurality of qudits are provided in the second ring of each unit cell. If four of the first plurality of qudits are each able to interact with two SEBs, then the condition that each SEB interacts with three of the first plurality of qudits can be met.

In preferred embodiments, the SEBs, the first plurality of qudits and the second plurality of qudits are arranged in a regular two-dimensional array, each SEB, each one of the first plurality of qudits and each one of the second plurality of qudits being located on a respective point of the array. In particular, it is preferred that the array is a square lattice, as square arrays have been found to be particularly suitable for manufacturing with existing nanofabrication techniques of the kind suitable for producing silicon-based quantum processors.

Preferably, particularly where the array is a square lattice, each of the points of the array nearest each of the points occupied by the SEBs, other than the point occupied by the reservoir, is occupied by one of the first plurality of qudits. In the case of a square lattice in which the reservoir occupies one point, there are four points nearest the reservoir and thus four SEBs. It is additionally preferred that each of the points of the array nearest each of the points occupied by the SEBs, other than the point occupied by the reservoir, is occupied by one of the first plurality of qudits. There will be eight such points (and thus eight of the first plurality of qudits) in each unit cell in these embodiments. These eight qudits of the first plurality of qudits form the first ring in these embodiments (in embodiments where the first plurality of qudits are provided in a first ring as described above). Most preferably, each of the points nearest each of the points occupied by the first plurality of qudits, other than those occupied by SEBs, is occupied by one of the second plurality of qudits. There are 12 such points (and thus 12 of the second plurality of qudits that are able to interact with the first plurality of qudits) in each unit cell in these embodiments. These 12 of the second plurality of qudits may form a second ring in the preferred embodiments described above where such a ring is present. There may be additional qudits in the second plurality (e.g. in a third ring around the second ring), or the 12 of the second plurality of qudits that are able to interact with the ancilla qudits could be all of the qudits in the second plurality.

Preferably the unit cells are arranged in a regular pattern. The pattern may be configured such that at least some of the second plurality of qudits of each unit cell are each able to interact with one or more second plurality of qudits of one or more other unit cells. The more qudits of different unit cells interact with one another in this manner, the greater the connectivity of the processor.

The invention also provides a method of using the silicon-based quantum processor defined above, the method comprising the steps of: initialising charges, which includes the steps of: transferring charge carriers from the reservoir to the plurality of SEBs; transferring charge carriers from the plurality of SEBs to the first plurality of qudits; and transferring charge carriers from the first plurality of qudits to the second plurality of qudits. Typically the step of initialising charges is performed before the processor begins performing computations and does not need to be repeated between individual calculations.

Preferably, in initialising the charges in the manner defined above, at a first time, the step of transferring charge carriers from the reservoir to the plurality of SEBs is performed; at a second time a step of transferring charge carriers from the plurality of SEBs to a first group of the first plurality of qudits is performed; and at a third time there are performed simultaneous steps of transferring charge carriers from the plurality of SEBs to a second group of the first plurality of qudits, and transferring charge carriers from the first group of the first plurality of qudits to a first group of the second plurality of qudits.

In preferred implementations the method further comprises the step of qudit spin initialisation, which includes allowing interaction between the second plurality of qudits and the first plurality of qudits. The first plurality of qudits may be placed into a known state before allowing this interaction—for example, each of the first plurality of qudits at this stage could contain a charge carrier in a spin down state. Most preferably, the step of qudit spin initialisation is performed in a first time step for a first group of the second plurality of qudits and, after the first time step, a second time step for a second group of the second plurality of qudits.

The method may further comprise a step of spin readout which involves exchanging charge carriers between the second plurality of qudits and the first plurality of qudits, or providing spin tunnels, and reading the states of the first plurality of qudits with the SEBs.

Preferably there are three groups of data qudits in the first ring that are readout in three time steps.

### BRIEF DESCRIPTION OF DRAWINGS

FIG. 1 shows a unit cell of a silicon-based quantum processor in accordance with an embodiment of the invention;

FIG. 2 shows a plurality of unit cells of the kind shown in FIG. 1 as arranged in a silicon-based quantum processor in accordance with an embodiment of the invention;

FIG. 3 illustrates the sparse 2D connectivity of the processor of FIGS. 1 and 2;

FIG. 4 illustrates steps of a charge initialisation process in the processor of FIGS. 1-3;

FIG. 5 illustrates steps of a spin initialisation process in the processor of FIGS. 1-3;

FIG. 6 illustrates the steps of a spin readout process in the processor of FIGS. 1-3;

FIG. 7 illustrates the sparse 2D connectivity of a silicon-based quantum processor in accordance with a second embodiment of the invention;

FIG. 8 shows a unit cell of an example of a silicon-based quantum processor in accordance with a third embodiment of the invention;

FIG. 9 illustrates steps of a charge initialisation process in the FIG. 8 embodiment;

FIG. 10 illustrates steps of a spin initialisation process in the FIG. 8 embodiment; and

FIG. 11 illustrates steps of a spin readout process in the FIG. 8 embodiment.

### DETAILED DESCRIPTION

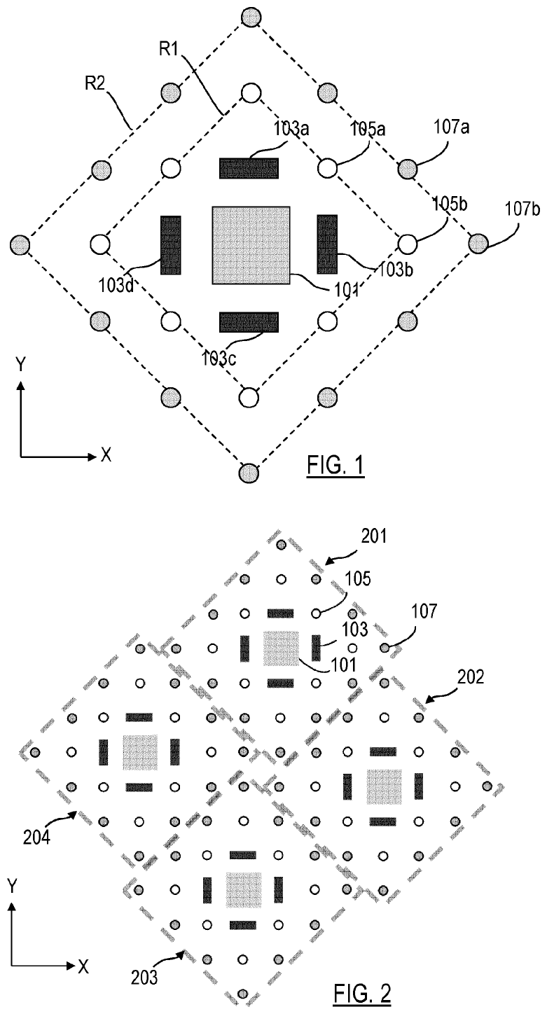

FIG. 1 shows an example of a unit cell in accordance with an embodiment of the invention. The unit cell comprises a charge reservoir 101, around which there are four single-electron boxes (SEBs) 103a, 103b, 103c, 103d arranged in a rectangular manner. The charge reservoir provides a supply of charge carriers, typically electrons, which can be transported into the SEBs. The SEBs 103a, 103b, 103c, 103d are gated islands each separated from the reservoir by a respective tunnel barrier. The transport of charge carriers from the reservoir to the islands of the SEBs 103a, 103b, 103c, 103d can be controlled by varying the gate voltage applied to the islands. In some embodiments, the islands of the SEBs may confine more than one charge carrier at one, in which case the number of charge carriers confined on the island is a function of the applied gate voltage.

The unit cell includes a first plurality of qudits 105a, 105b that will be used as ancilla qudits in use. These eight ancilla qudits 105a, 105b are arranged in a first ring R1 around the SEBs 103a, 103b, 103c, 103d and charge reservoir 101. The ancilla qudits in this drawing are represented by the white circles. The eight ancilla qudits 105a, 105b are each arranged so as to interact with at least one of the SEBs, i.e. such that they can exchange charge carriers and influence one another's state. For example, the ancilla qudit labelled 105a interacts with two of the SEBs 103a, 103b. The ancilla qudit labelled 105b interacts with only one SEB 103b. In the arrangement shown, four of the ancilla qudits (those arranged near the ‘corners’ of the rectangle formed by the layout of the SEBs 103a, 103b, 103c, 103d, including the ancilla qudit labelled 105a) interact with two SEBs 103a, 103b, 103c, 103d and the other four ancilla qudits (including the ancilla qudit labelled 105b) are able to interact with only one SEB.

The processor also includes a second plurality of qudits 107a, 107b, which will be used as data qudits in use. In this embodiment there are 12 data qudits 107a, 107b arranged in a second ring R2 around the ancilla qudits. In this drawing the data qudits are shown as shaded circles. Each of the data qudits in the second ring R2 is arranged to interact with at least one ancilla qudit—for example, the data qudit labelled 107a is able to interact with two ancilla qudits, 105a and 105b, while the data qudit labelled 107b is configured to interact with only one ancilla qudit 105b. Data qudits and ancilla qudits that are arranged to interact may for example exchange charge carriers and influence one another's state.

The ancilla qudits and data qudits may be implemented as gated semiconductor quantum dots configured to confine the charge carriers under application of a suitable gate voltage. The states of the qudits may correspond to spin states of the charge carriers confined by the qudits, in which case the processor will be subject to a magnetic field in use in order to produce the different energy levels of the different spin states. The processor may comprise a magnetic field generating component for this purpose.

The reservoir, SEBs, ancilla qudits and data qudits are arranged in accordance with a square lattice, which is a kind of regular two-dimensional array. The points of this lattice are arranged in rows and columns extending along the perpendicular directions labelled X and Y and are regularly spaced along these directions by the same interval. For example, the SEB labelled 103b occupies the point of the lattice immediately adjacent to that occupied by the charge reservoir 101. It can be seen that the arrangement of the SEBs 103a, 103b, 103c, 103d in this embodiment is such that each of the lattice points nearest the point occupied by the reservoir (of which there are four—the two points above and below in the Y direction, and the two points either side in the X direction) is occupied by an SEB 103a, 103b, 103c, 103d. Similarly, each of the lattice points nearest the SEBs 103a, 103b, 103c, 103d, other than that occupied by the reservoir 101, is occupied by an ancilla qudit 105a, 105b; and each of the lattice points nearest each of the ancilla qudits 105a, 105b, other than those occupied by SEBs 103a, 103b, 103c, 103d, is occupied by a data qudit 107a, 107b in the second ring R2.

In alternative embodiments, this unit cell could include additional data qudits, for example arranged in a third ring around the second ring R2.

A quantum processor in accordance with an embodiment of the invention comprises a plurality of unit cells such as that shown in FIG. 1. The unit cells may be arranged in accordance with a regular pattern, an example of which is shown in FIG. 2. This drawing shows four unit cells 201, 202, 203, 204 though it will be appreciated that a processor could incorporate many more unit cells than are shown here. The state of each of the data qudits 107 can be read directly since each data qudit 107 is configured to interact with at least one ancilla qudit 105.

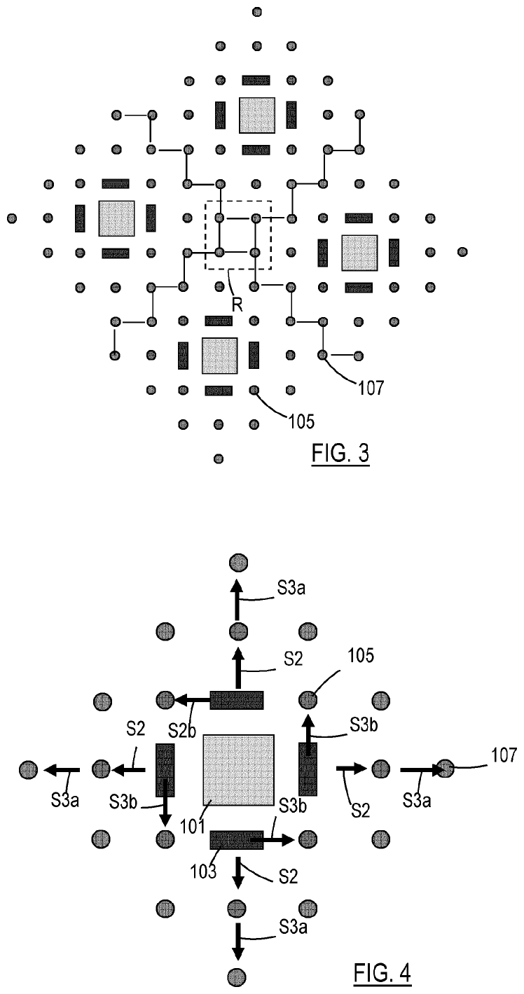

In this pattern, the charge reservoirs 101 of the unit cells 201 and 203 are offset from one another along the X direction by one lattice point. Similarly, the reservoirs of the unit cells 202 and 204 are offset from one another by one lattice point in the Y direction. This layout achieves a reasonable degree of sparse 2D connectivity while allowing all of the data qudits to be read, as will be shown below with reference to FIG. 3.

FIG. 3 illustrates the sparse 2D connectivity of data qudits 107 in the processor architecture of FIG. 2. Lines between the data qudits 107 indicate which other data qudits each data qudit is configured to interact with. It should be noted that this drawing only shows connections between data qudits visible in the area shown—the qudits around the edges of the region shown may be connected to other data qudits not shown. In the region R surrounded by the dashed box in the centre, where corners of the unit cells 201, 202, 203, 204 meet, each of the data qudits 107 is connected to three other data qudits. The data qudits 107 in this region thus have 2D connectivity. By contrast, outside of this region, the data qudits 107 whose connections are shown have linear connectivity since each data qudit 107 is configured to interact with two other data qudits 107 and the connections are arranged in a linear manner. This arrangement, in which there are regions R having 2D connectivity spaced from one another by regions of linear connectivity, is called “sparse 2D connectivity”. The 2D connectivity of the processor could be increased by adding additional data qudits 107 (e.g. in a third ring in each unit cell around the second ring R2), but these additional qudits would not be able to be read directly since they would not be able to interact with any ancilla qudits 105.

FIG. 4 illustrates the steps of a method of initialising charges in the quantum processor of FIGS. 1-3. Charge initialisation typically takes place before performing computations using the quantum processor and its purpose is to supply each ancilla qudit 105 and data qudit 107 with charge carriers. In a first step, charge carriers (e.g. electrons) are transferred from the reservoir to the SEBs. Then, in a second step, charge carriers are transported from the SEBs to a first group of ancilla qudits 105 as shown by the arrows labelled S2. In a third step, the charge carriers transported in the second step are transported from the first group of ancilla qudits 105 to a first group of data qudits 107 as indicated by the arrows labelled S3a. Also in the third step, simultaneous with the transport of charge carriers to the first group of data qudits 107, charge carriers are transported from each of the SEBs to a second groups of ancilla qudits 105 in the manner indicated by the arrows labelled S3b. The method can proceed in a similar manner until all of the data qudits 107 and ancilla qudits 105 in the unit cell are provided with charge carriers. Typically the charge initialisation will be performed such that each qudit in the unit cell is loaded with a single charge carrier (e.g. an electron), but in some applications it may be desirable to load the qudits with plural charge carriers.

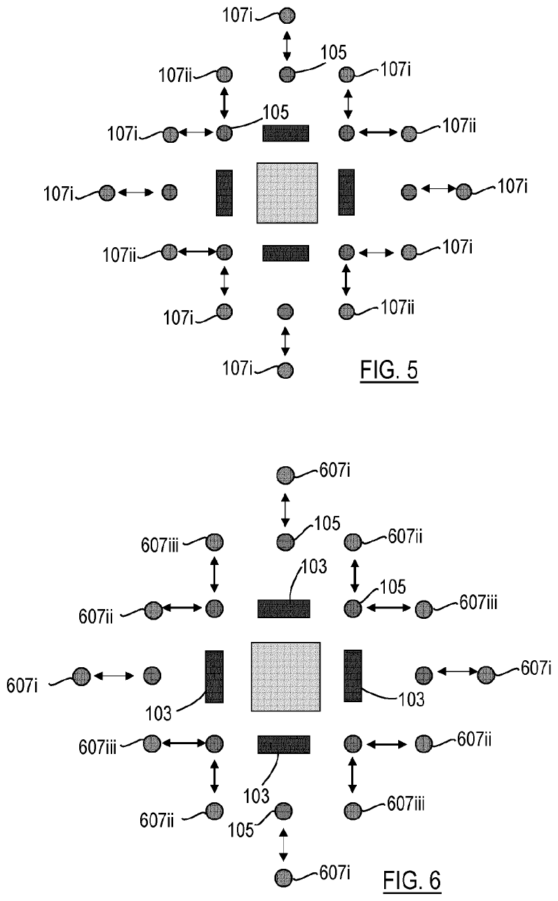

FIG. 5 illustrates an example of a method of spin initialisation in the processor of FIGS. 1-3. Spin initialisation is performed after charge initialisation has taken place (e.g. by the method illustrated in FIG. 4) and has the purpose of preparing the states of the ancilla qudits 105 and data qudits 107 for performing calculations. At the beginning of spin initialisation, the ancilla qudits 105 are placed into a known state, for example spin-down. At this stage, the states of the data qudits 107 are unknown. Then, in a first time step, the ancilla qudits 105 are allowed to interact with a first group of data qudits 107i. In a second time step, at a later time, the ancilla qudits are allowed to interact with a second group of data qudits 107ii. The interactions between the qudits in the spin initialisation process may be spin-dependent tunnelling.

After performing calculations using the quantum processor described above, a spin readout process may be performed in order to read the results of the calculations. FIG. 6 illustrates an example of a process for performing spin readout using the quantum processor of FIGS. 1-3. Each of three groups of data qudits (a first group of data qudits 607i; a second group of data qudits 607ii; and a third group of data qudits 607iii) are allowed to interact with the ancilla qudits 105 in turn. This interaction can comprise either transporting charges carriers from the data qudits 607i, 607ii, 607iii to the ancilla qudits 105 or providing spin tunnels (typically in a spin-dependent manner) between the data qudits 607i, 607ii, 607iii and the ancilla qudits 105. The states of the ancilla qudits 105 may then be read via the SEBs 103, which are configured to interact with the data qudits 105.

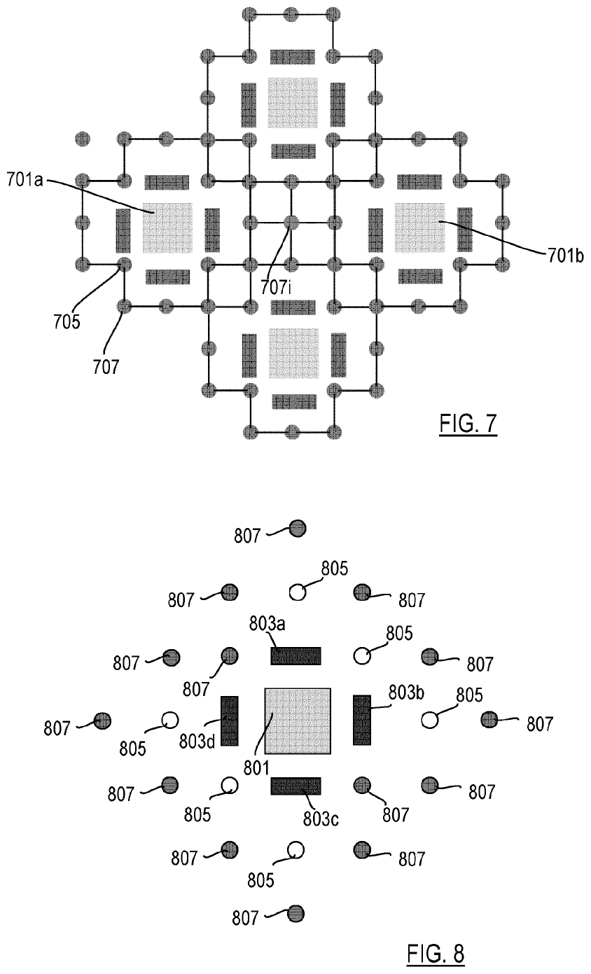

FIG. 7 shows schematically part of a silicon-based quantum processor in accordance with a further embodiment of the invention. This processor has the same unit cells as that described with reference to FIGS. 1-5 above, but the unit cells here are arranged in accordance with a different pattern. In particular, the charge reservoirs are arranged in alignment with one another along the rows and columns of the square lattice—for example, the charge reservoir 701a is on the same row as the charge reservoir 701b. It can be seen that in this layout, some of the data qudits 707 are shared between unit cells—for example, the data qudit labelled 707i here is shared between the four unit cells shown in the drawing.

In the embodiments described above, the first plurality of qudits and the second plurality of qudits are arranged in rings (e.g. a first ring and a second ring, as in FIG. 1) around the SEBs and charge reservoirs. FIG. 8 shows the unit cell of a processor in accordance with an alternative embodiment of the invention, in which the first plurality and second plurality of qudits are not arranged in rings. Like the previous examples, the unit cell contains a charge reservoir 801 and four SEBs 803a, 803b, 803c, 803d arranged in a rectangular fashion around the charge reservoir. There is a first plurality of qudits 805 (shown in this drawing as white circles) arranged around the charge reservoir 801 and SEBs 803a, 803b, 803c, 803d. Like the previous embodiments, the layout of this unit cell is based on a square lattice. However, unlike in the FIG. 1 embodiment, where all of the points on the lattice nearest the SEBs 803a, 803b, 803c, 803d were occupied by ancilla qudits, two of the lattice points nearest the SEBs (one between SEBs 803a and 803d and the other between SEBs 803b and 803c) are occupied by qudits belonging to a second plurality of qudits 807, which will be used as data qudits in use. Therefore, the two data qudits 807 in positions nearest the SEBs will not have their states read by the SEBs 803a, 803b, 803c, 803d in use. The only qudits whose states will be read by the SEBs 803a, 803b, 803c, 803d are the six ancilla qudits provided by the first plurality of qudits 805. The two data qudits 807 in locations that were occupied by ancilla qudits in the previous embodiments cannot have their states read directly since they are not arranged to interact with any ancilla qudits 805. Therefore, this arrangement is useful where it is not necessary to read the states of all of the data qudits 807 but where a higher density of data qudits 807 is desired. There are no other data qudits 807 in this embodiment, but in other embodiments, additional data qudits 807 could be provided around those shown.

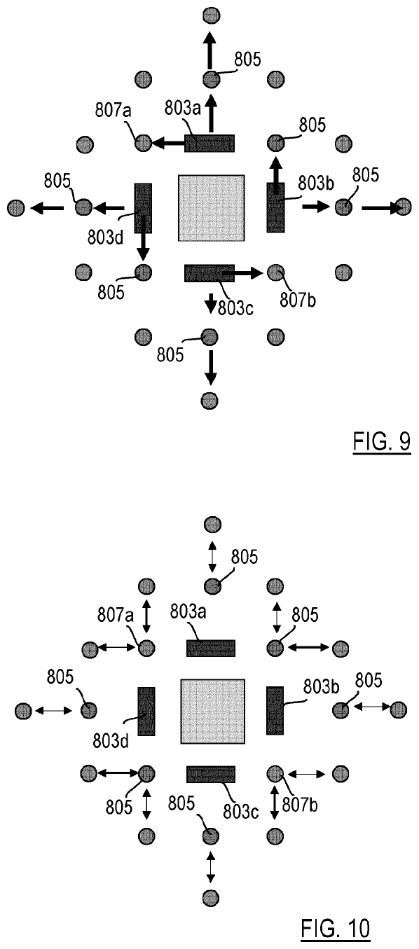

FIG. 9 shows steps of a charge initialisation process in the FIG. 8 unit cell, with arrows showing the movement of charge carriers. In a first time step, charge carriers are moved from the SEBs to the ancilla qudits 805. In a second time step, charge carriers are simultaneously moved from the SEBs to those of the data qudits 807a, 807b that are arranged to interact with the SEBs 803a, 803b, 803c, 803d and from the ancilla qudits 805 to others data qudits 807.

FIG. 10 shows steps of a spin initialisation process in the FIG. 8 unit cell. In a first time step, the ancilla qudits 805 are each allowed to interact with a respective one of the data qudits 807. Also in the first time step, the data qudits 807a, 807b in locations that were occupied by ancilla qudits in the previous embodiments are each allowed to interact with an adjacent data qudit 807. Then, in a second time step, the two data qudits 807a, 807b and the two ancilla qudits 805 nearest the reservoir are allowed to interact with a different data qudit 805 to that with which they interacted in the first time step.

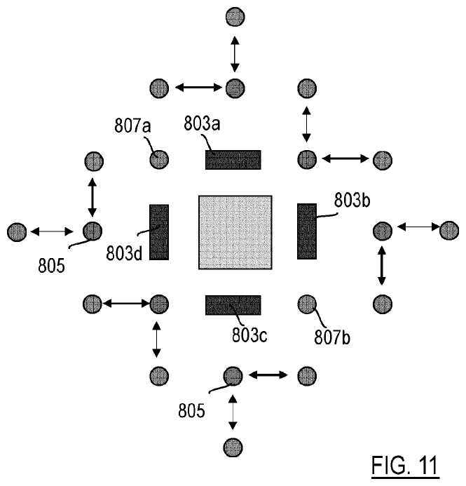

FIG. 11 shows steps of a spin readout process in the unit cell of FIG. 8. A first group of the data qudits 807 interact with the ancilla qudits 805 (either by exchanging charge carriers or providing spin tunnels) and the ancilla qudits 805 are then read using the SEBs 803a, 803b, 803c, 803d. Then, the ancilla qudits 805 interact with a second group of the data qudits 807 and again the states of the ancilla qudits 805 are read by the SEBs 803a, 803b, 803c, 803d.

1. A silicon-based quantum processor, comprising a plurality of unit cells having respective qudits that can interact with one another, directly or indirectly, wherein each unit cell comprises:
a charge reservoir;
a plurality of single-electron boxes, SEBs, that are gated charged islands separated from the charge reservoir by a tunnel barrier;
a first plurality of qudits for use as ancilla qudits, provided around each SEB, and to which the SEB is sensitive, wherein the first plurality of qudits are provided around the charge reservoir and the plurality of SEBs; and
a second plurality of qudits for use as data qudits provided around the first plurality of qudits, wherein each of the second plurality of qudits can interact with at least one of the first plurality of qudits so that the state of each of the second plurality of qudits can be read by one of the plurality of SEBs from a neighbouring one of the first plurality of qudits.

2. The silicon-based quantum processor of claim 1, wherein at least some of the second plurality of qudits of one or more of the unit cells are configured to interact with at least some of the second plurality of qudits of one or more other unit cells.

3. The silicon-based quantum processor of claim 1, wherein, within each unit cell:
the first plurality of qudits are arranged in a first ring around the charge reservoir and the plurality of SEBs; and
the second plurality of qudits comprise qudits arranged in a second ring around the first ring.

4. The silicon-based quantum processor of claim 3, wherein at least some of the qudits in the second ring of a first unit cell are configured to interact with at least some of the qudits in the second ring of a second unit cell.

5. The silicon-based quantum processor of claim 3, wherein the second plurality of qudits in each unit cell are provided in the second ring and in a third ring, which surrounds the second ring, wherein each of the qudits in the second ring can interact with at least one of the qudits in the third ring;
wherein preferably at least some of the qudits in the third ring of a first unit cell are configured to interact with at least some of the qudits in the third ring of a second unit cell.

6. The silicon-based quantum processor of claim 1, wherein, within each unit cell, four SEBs are provided around the charge reservoir in a rectangular configuration.

7. The silicon-based quantum processor of claim 6, wherein three of the first plurality of qudits are provided around each of the four SEBs of each unit cell.

8. The silicon-based quantum processor of claim 1, wherein the SEBs, the first plurality of qudits and the second plurality of qudits are arranged in a regular two-dimensional array, preferably a square lattice, each SEB, each one of the first plurality of qudits and each one of the second plurality of qudits being located on a respective point of the array.

9. The silicon-based quantum processor of claim 8, wherein each of the reservoirs is arranged on a respective point of the array and wherein, within each unit cell, each of the points of the lattice nearest the reservoir is occupied by one of the SEBs.

10. The silicon-based quantum processor of claim 9, wherein each of the points of the array nearest each of the points occupied by the SEBs, other than the point occupied by the reservoir, is occupied by one of the first plurality of qudits;
wherein preferably each of the points nearest each of the points occupied by one of the first plurality of qudits qudits, other than those occupied by SEBs, is occupied one of the second plurality of qudits.

11. The silicon-based quantum processor of claim 1, wherein the unit cells are arranged in a regular pattern.

12. A method of using the silicon-based quantum processor of claim 1, the method comprising the steps of:
initialising charges, which includes the steps of:
transferring charge carriers from the reservoir to the plurality of SEBs;
transferring charge carriers from the plurality of SEBs to the first plurality of qudits; and
transferring charge carriers from the first plurality of qudits to the second plurality of qudits.

13. The method of claim 12 wherein, at a first time, the step of transferring charge carriers from the reservoir to the plurality of SEBs is performed; at a second time a step of transferring charge carriers from the plurality of SEBs to a first group of the first plurality of qudits is performed; and at a third time there are performed simultaneous steps of transferring charge carriers from the plurality of SEBs to a second group of the first plurality of qudits, and transferring charge carriers from the first group of the first plurality of qudits to a first group of the second plurality of qudits.

14. The method of claim 12 further comprising the step of qudit spin initialisation, which includes allowing interaction between the second plurality of qudits and the first plurality of qudits;
wherein preferably the step of qudit spin initialisation is performed in a first time step for a first group of the second plurality of qudits and, after the first time step, a second time step for a second group of the second plurality of qudits.

15. The method of claim 12, further comprising a step of spin readout which involves exchanging charge carriers between the second plurality of qudits and the first plurality of qudits, or providing spin tunnels, and reading the states of the first plurality of qudits with the SEBs.
